(19) United States
(12) Patent Application Publication
(10) Pub. No.: US 2005/0057504 A1
(43) Pub. Date: Mar. 17, 2005

(54) Mouse

(75) Inventors: Hiroaki Akiyama, Osaka (JP); Tsuyoshi Watanabe, Osaka (JP); Satoshi Nakagawa, Tokyo (JP)

Correspondence Address: BANNER & WITCOFF, 1001 G STREET N W, SUITE 1100, WASHINGTON, DC, 20001, US

(73) Assignee: Kokuyo Co., Ltd., Osaka (JP)

(21) Appl. No.: 10/651,084

(22) Filed: Aug. 29, 2003

(51) Int. Cl. G09G 5/08

(52) U.S. Cl. 345/163

(57) ABSTRACT

A mouse M that is used as a pointing device for an information processing unit such as a personal computer comprises a body 1 having at least a button as an input operating portion, a traveling direction detecting portion 3 that detects a direction of traveling by the use of an optical means and a sliding portion 23 made of a skiddy material is arranged to surround the traveling direction detecting portion 3 and is so arranged that the sliding portion 23 forms a bottom face of the mouse M in order to move the mouse M with ease and to protect the traveling direction detecting portion from dust.

### FIELD OF THE INVENTION

This invention relates to a mouse used as a pointing device for an information processing unit such as a personal computer.

### BACKGROUND OF THE INVENTION

Conventionally so called an optical mouse used as a pointing device for a personal computer uses a CMOS element or the like as a traveling direction detecting portion and detects a traveling direction by the use of an optical means.

However, a top plate on which the above-arranged mouse is placed is not always in a dust-free environment. Dust on the top plate attaches to a traveling direction detecting portion of the mouse after a long term use, which deteriorates a quality of an image obtained by the traveling direction detecting portion and hinders the mouse from operating normally.

### SUMMARY OF THE INVENTION

In order to solve the above-mentioned problems the present claimed invention is so arranged to prevent dust from attaching around the traveling direction detecting portion.

A mouse in accordance with the present claimed invention is used as a pointing device for an information processing unit such as a personal computer and comprises a traveling direction detecting portion that detects a traveling direction by the use of an optical means and a sliding portion made of a skiddy material that is arranged to surround the traveling direction detecting portion arranged on a bottom face of the mouse.

In accordance with the arrangement, the mouse can be moved smoothly due to the sliding portion and the traveling direction detecting portion can be protected from dust because the sliding portion will prevent dust from entering the traveling direction detecting portion.

In order to protect the traveling direction detecting portion from dust more effectively, the sliding portion may be arranged generally over a frontward and a sideward of the traveling direction detecting portion.

If the sliding portion is arranged in a horseshoe shape or in a shape to surround the traveling direction detecting portion between the traveling direction detecting portion and a peripheral edge of the bottom face of the mouse, it is possible to protect the traveling direction detecting portion from dust more effectively.

In order to protect the traveling direction detecting portion from dust further more effectively, the mouse may comprise a body having at least an input operating portion, the traveling direction detecting portion, a hand placing portion that locates at a lower portion of the body and on which a hand of an operator can be put, and the sliding portion arranged at a bottom face of the hand placing portion.

As an example of a concrete embodiment of the mouse conceived is that the hand placing portion is in a shape of a sheet.

Further, the sliding portion made of tetrafluoroethylene resin can be conceived as a concrete embodiment of the mouse.

As mentioned above, since the mouse of the present claimed invention is provided with the sliding portion made of a skiddy material to surround the traveling direction detecting portion, it is possible to move the mouse smoothly and to prevent dust from entering the traveling direction detecting portion through the sliding portion, thereby to protect the traveling direction detecting portion from dust as well.

### BRIEF DESCRIPTION OF THE DRAWINGS

FIG. 1 is a perspective view of a mouse in accordance with one embodiment of the present claimed invention.

FIG. 2 is a plane view of the mouse in accordance with the embodiment.

FIG. 3 is a side view of the mouse in accordance with the embodiment.

FIG. 4 is a front view of the mouse in accordance with the embodiment.

FIG. 5 is a back view of the mouse in accordance with the embodiment.

FIG. 6 is a bottom view of the mouse in accordance with the embodiment.

FIG. 7 is a longitudinally cross-sectional view showing a state of a hand placing portion in FIG. 4.

### DETAILED DESCRIPTION OF THE PREFERRED EMBODIMENTS

An embodiment of the present claimed invention will be described in detail with reference to the accompanying drawings.

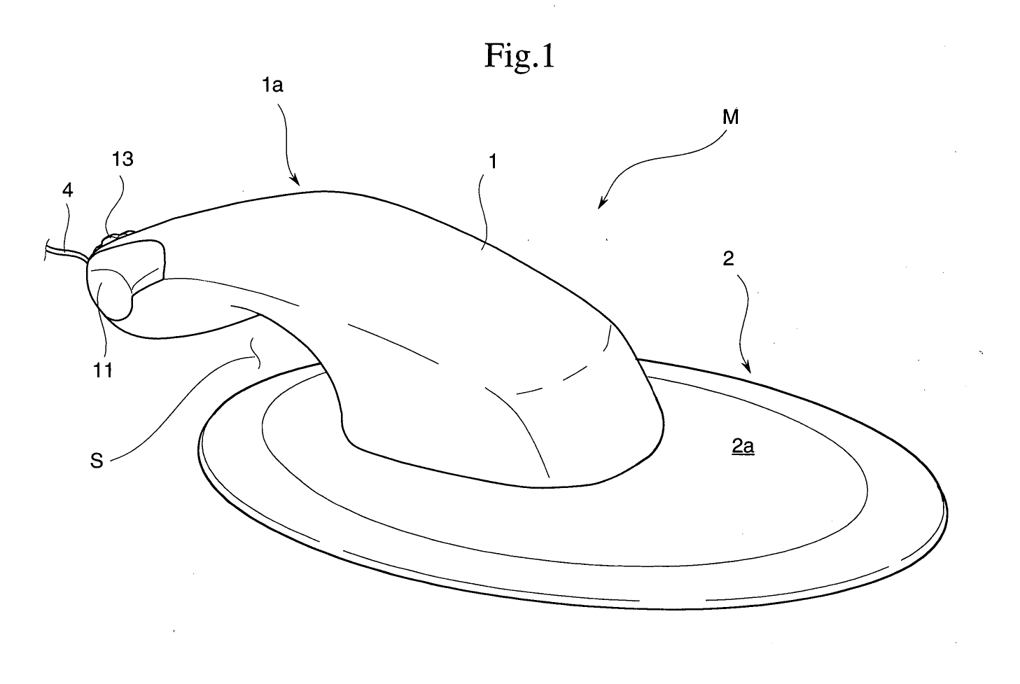

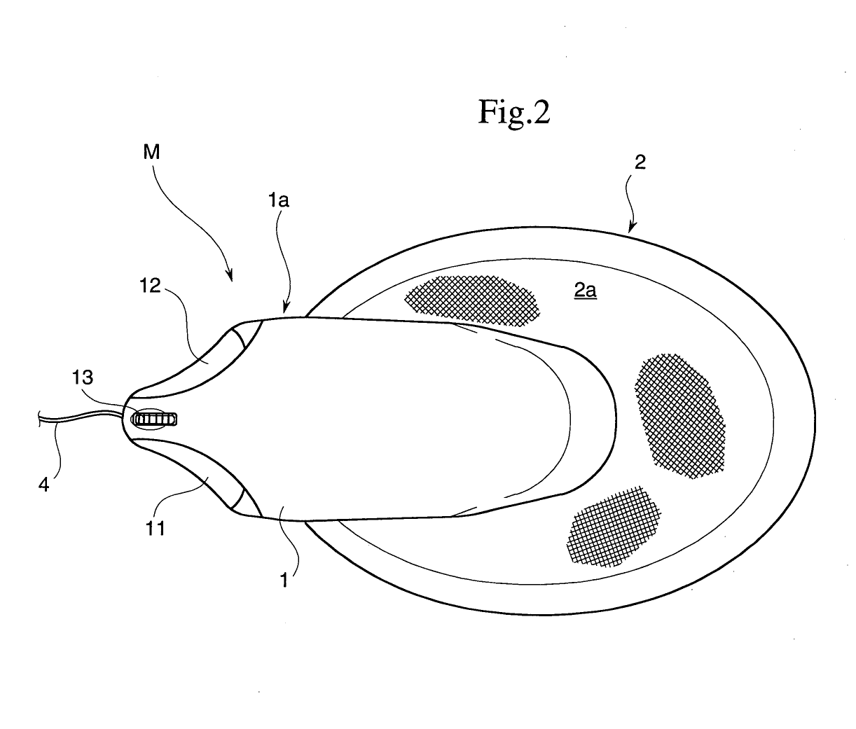

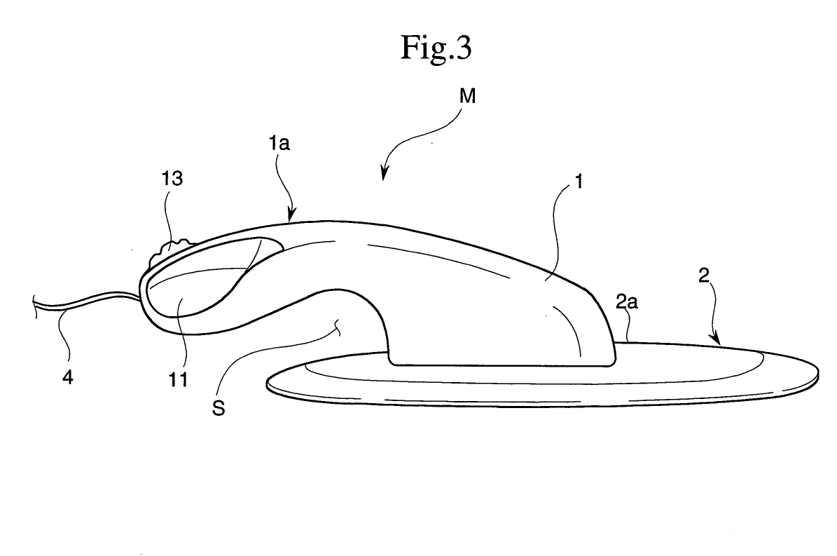

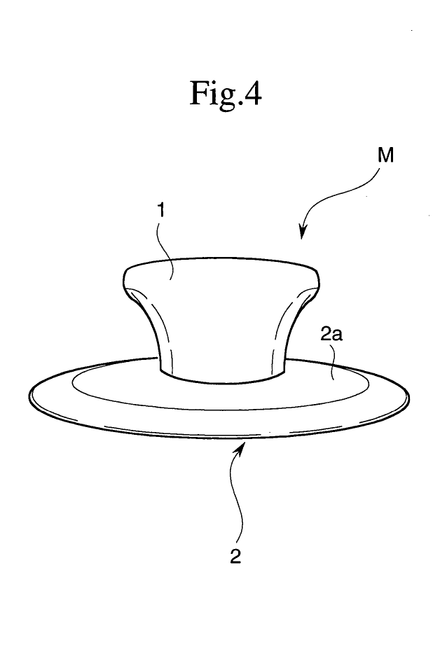

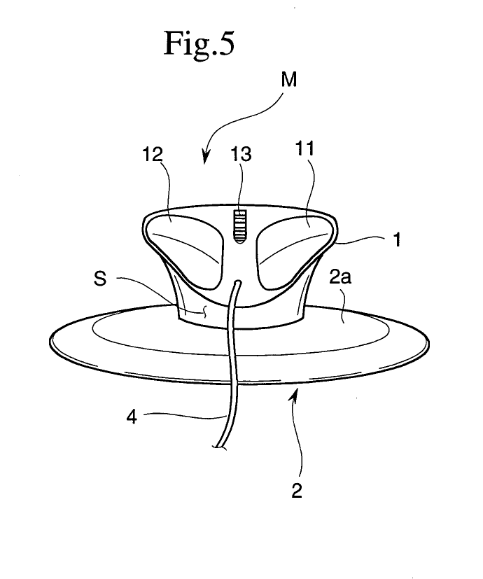

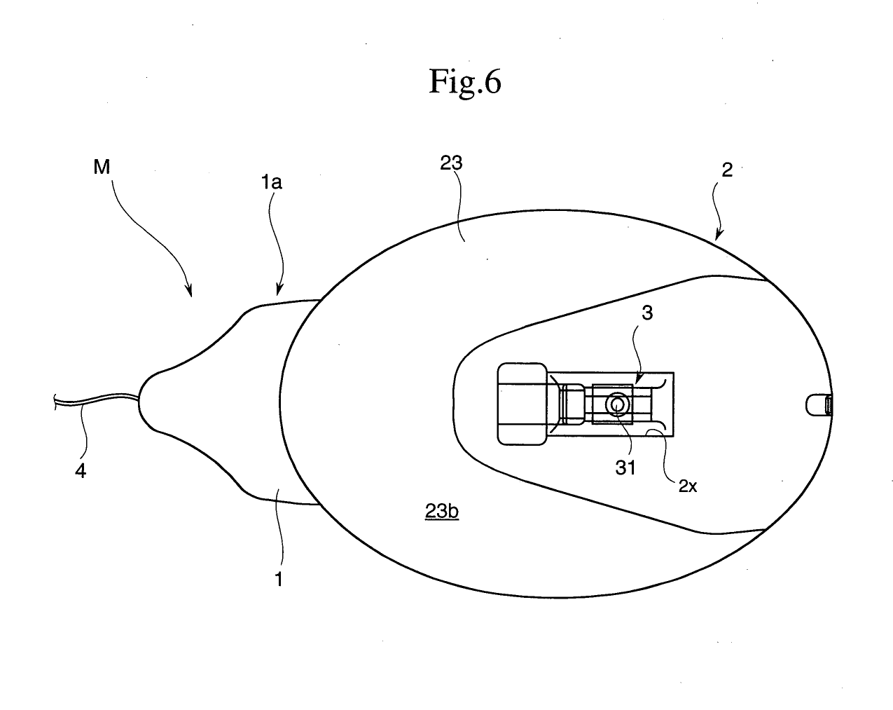

A mouse M in accordance with the embodiment, whose perspective is shown in FIG. 1, whose plane view is shown FIG. 2, whose side view is shown in FIG. 3, whose front view is shown in FIG. 4, whose back view is shown in FIG. 5 and whose bottom view is shown in FIG. 6, comprises a body 1 that has buttons 11, 12 as an input operating portion and a wheel 13 at its front portion, a hand placing portion 2 in a shape of a sheet extending back and forth and right and left from a bottom end portion of the body 1 and a traveling direction detecting portion 3 that scans a traveling direction of the mouse M by the use of an optical means. The front here means a direction heading an operator.

More concretely, as shown in FIG. 1, FIG. 2 and FIG. 3, the body 1 is arranged to stand from a general center of the hand placing portion 2 in an elliptical shape of a sheet and a projecting portion 1a whose shape is tapered toward the forward is arranged to project forward from an upper portion of the body 1. As shown in FIG. 1 and FIG. 2, the wheel 13 is arranged at a center of a width direction of the front end portion of the projecting portion 1a and the buttons 11, 12 are arranged right and left across the wheel 13. As shown in FIG. 1 and FIG. 3, a space S is formed under the projecting portion 1a having the buttons 11 and 12 to insert a finger. The buttons 11 and 12 can be operated with a finger pushed downward or pulled forward.

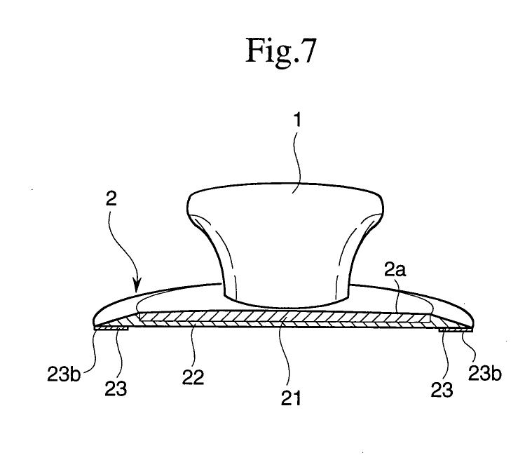

The hand placing portion 2 has, as shown in FIG. 6 and FIG. 7 in which a longitudinally cross-sectional view of a part of the hand placing portion 2 shown in FIG. 2 is shown, a soft layer 21 made of a soft material, urethane in this embodiment, and a core layer 22 made of a more rigid material. In addition, a hand placing face 2a as an upper face of the core layer 22 and as a face on which a hand is put comprises the soft layer 21. The core layer 22 is arranged under the soft layer 21. An opening 2x is arranged at a center of a bottom face of the hand placing portion 2 and the traveling direction detecting portion 3 is arranged at the opening 2x.

In this embodiment, the mouse M can be traveled with keeping the hand put on the hand placing portion 2. Further, a wrist, an outer portion of a thumb and an outer portion of a pinkie can be placed on the hand placing portion 2.

Then the mouse M can be moved by hanging an index finger and a middle finger on the buttons 11, 12 respectively and moving the hand horizontally with keeping the wrist placed on the hand placing portion 2.

The traveling direction detecting portion 3 comprises, as shown in FIG. 6, a traveling direction detecting portion body 31 arranged above the opening 2x of the hand placing portion 2 inside the body 1 and a traveling direction calculating circuit, not shown in drawings, arranged inside the body 1 and detects a traveling direction by the use of the optical means. More specifically, the traveling direction detecting portion body 31 comprises a CMOS image sensor and it detects an image of the top plate, a traveling direction of the mouse M is calculated by the traveling direction calculating circuit and then the traveling direction of the mouse M is sent to the connected information processing unit, not shown in drawings.

In this embodiment, as shown in FIG. 6 and FIG. 7, a sliding portion 23 made of a skiddy material, tetrafluoroethylene resin in this embodiment, is arranged in a horseshoe shape to surround the opening 2x under the core layer 22 between the opening 2x and a peripheral edge of the mouse M. A bottom face 23b of the sliding portion 23 forms a bottom face of the mouse M and the mouse M is used with making the bottom face 23b of the sliding portion 23 contact with an upper face of the top plate of the desk. Further, in this embodiment the hand placing portion 2 is flexible.

As mentioned above, since the bottom face 23b of the sliding portion 23 forms the bottom face of the mouse M and the sliding portion 23 made of a skiddy material is arranged in the horseshoe shape to surround the opening 2x, the mouse M can be moved smoothly and the traveling direction detecting portion 3 can be protected from dust because the sliding portion 23 will prevent dust from entering the traveling direction detecting portion 3.

In addition, since the hand placing portion 2 is flexible, it is possible to use the mouse M with keeping a part of the hand floating from the hand placing portion 2.

Especially, since the sliding portion 23 is arranged generally over a frontward and a sideward of the opening 2x, a generally whole area of the bottom face of the mouse M acts as a lid to cover the traveling direction detecting portion 3, thereby to protect the traveling direction detecting portion 3 from dust effectively.

In addition, since the hand placing portion 2 in a shape of a sheet is arranged under the body 1 and the sliding portion 23 is arranged under the hand placing portion 2, the sliding portion 23 is pushed against the upper face of the top plate by a weight of the hand if the hand of the operator is put on the hand placing portion 2, thereby to prevent dust from entering more effectively and further to protect the traveling direction detecting portion 3 against dust effectively.

The present claimed invention is not limited to the above-described embodiments.

For example, the hand placing portion may not be in a shape of a sheet. For example, it may be formed in a shape of a plate. Or a dent is arranged on a mouse to place a hand on so that an inner side of the dent constitutes the body and the dent constitutes the hand placing portion. Further, the hand placing portion may not be flexible. In this arrangement, it is possible to prevent dust from entering the traveling direction detecting portion as far as the sliding portion is arranged under the hand placing portion.

In addition, the hand placing portion may be omitted. It is possible to prevent dust from entering the traveling direction detecting portion as far as a sliding portion is arranged on the bottom face of the mouse.

Further, the sliding portion is not necessarily in a shape of the horseshoe. It may be in a shape to surround a circumference of the traveling direction detecting portion or may be arranged generally over the bottom face of the mouse except for the traveling direction detecting portion. In accordance with the arrangement, it is possible to protect the traveling direction detecting portion from dust. Further, if the sliding portion is arranged generally over the bottom face of the mouse except for the traveling direction detecting portion, it is possible to move the mouse smoothly in any state of use.

Even though the sliding portion is not arranged generally over the whole area of the bottom face of the mouse, the traveling direction detecting portion can be protected from dust as far as the sliding portion is arranged to surround the traveling direction detecting portion.

In addition, the body of the mouse and the input operating portion may not be in the shape of the above-described embodiment, it may be in a semicircle in a side view like a conventional mouse or in other shape.

Further, the sliding portion may be made of a material other than tetrafluoroethylene resin. Other component may be variously modified without departing from the spirit of the invention.

1. A mouse that is used as a pointing device for an information processing unit such as a personal computer and characterized by comprising a body having at least an input operating portion and a traveling direction detecting portion that detects a direction of traveling by the use of an optical means and a sliding portion made of a skiddy material is arranged to surround the traveling direction detecting portion wherein the sliding portion forms a bottom face of the mouse.

2. The mouse described in claim 1 and characterized by that the sliding portion is arranged generally over at least a frontward and a sideward of the traveling direction detecting portion.

3. The mouse described in claim 1, and characterized by that the sliding portion is arranged in a horseshoe shape or in a shape to surround the traveling direction detecting portion between the traveling direction detecting portion and a peripheral edge of the bottom face of the mouse.

4. The mouse described in claim 1, and characterized by that further comprising a hand placing portion on which a hand of an operator can be put and the sliding portion is arranged at a bottom face of the hand placing portion.

5. The mouse described in claim 4, and characterized by that the hand placing portion is in a shape of a sheet.

6. The mouse described in claim 1, and characterized by that the sliding portion is made of tetrafluoroethylene resin.

7. The mouse described in claim 2, and characterized by that further comprising a hand placing portion on which a hand of an operator can be put and the sliding portion is arranged at a bottom face of the hand placing portion.

8. The mouse described in claim 7, and characterized by that the hand placing portion is in a shape of a sheet.

9. The mouse described in claim 2, and characterized by that the sliding portion is made of tetrafluoroethylene resin.

10. The mouse described in claim 3, and characterized by that further comprising a hand placing portion on which a hand of an operator can be put and the sliding portion is arranged at a bottom face of the hand placing portion.

11. The mouse described in claim 10, and characterized by that the hand placing portion is in a shape of a sheet.

12. The mouse described in claim 3, and characterized by that the sliding portion is made of tetrafluoroethylene resin.

13. The mouse described in claim 4, and characterized by that the sliding portion is made of tetrafluoroethylene resin.

14. The mouse described in claim 5, and characterized by that the sliding portion is made of tetrafluoroethylene resin.
